(19) United States
(12) Patent Application Publication
(10) Pub. No.: US 2017/0053228 A1
(43) Pub. Date: Feb. 23, 2017

(54) METHOD AND SYSTEMS FOR FACILITATING SHIPPING TRANSACTIONS IN VIRTUAL DASHBOARD

(71) Applicants: John Lozito, Encinitas, CA (US); Joonyoul Choi, San Diego, CA (US)

(72) Inventors: John Lozito, Encinitas, CA (US); Joonyoul Choi, San Diego, CA (US)

(73) Assignee: Trakkx COM LLC, Encinitas, CA (US)

(21) Appl. No.: 15/243,666

(22) Filed: Aug. 22, 2016

Related U.S. Application Data
(60) Provisional application No. 62/209,594, filed on Aug. 25, 2015.
(60) Provisional application No. 62/208,503, filed on Aug. 21, 2015.
(60) Provisional application No. 62/277,701, filed on Jan. 12, 2016.
(60) Provisional application No. 62/277,709, filed on Jan. 12, 2016.

(51) Int. Cl. G06Q 10/08; G06F 3/0484; G06F 3/0482

(52) U.S. Cl. CPC G06Q 10/083; G06F 3/0482; G06F 3/04842

(57) ABSTRACT

Systems, methods, and apparatuses are presented for a uniquely designed digital interface including multiple dashboards to offer complete visibility to the users of freight companies with any business role in the logistics industry. In some embodiments, an Application View and an Administration View are provided in the digital dashboard interface that allows users to access their information related to one or more shipping transactions. In some embodiments, in the Application View, the Shipper, Broker, Carrier or Receiver can access order-centric dashboard via a personalized dashboard view and location (e.g., map)-centric dashboard via a Map menu. In the Administration View, the users with administrative privileges can manage company-level settings for assets, users, contacts, partnerships, alarms and application properties to streamline the Application View's feature behaviors and user experience tailored for the company's business practice.

### CROSS REFERENCE TO RELATED APPLICATIONS

This application claims the benefits of U.S. Provisional Application 62/209,594, filed Aug. 25, 2015, and titled, “METHODS AND SYSTEMS FOR MANAGING SHIPPING TRANSACTIONS,” U.S. Provisional Application 62/208,503, filed Aug. 21, 2015, and titled, “METHODS AND SYSTEMS FOR SHARING PARTNERSHIP DATA IN SHIPPING TRANSACTIONS,” U.S. Provisional Application 62/277,701, filed Jan. 12, 2016, and titled, “METHODS AND SYSTEMS FOR FACILITATING SHIPPING TRANSACTIONS IN VIRTUAL DASHBOARD,” and U.S. Provisional Application 62/277,709, filed Jan. 12, 2016, and titled, “METHODS AND SYSTEMS FOR TRACKING ASSETS OF SHIPPING TRANSACTIONS IN REAL TIME,” the disclosures of which are incorporated herein by reference in their entireties and for all purposes.

This application is also related to US non provisional applications (Attorney Docket No. 1402872.00006_TRX006), titled “METHODS AND SYSTEMS FOR MANAGING SHIPPING TRANSACTIONS,” (Attorney Docket No. 1402872.00007_TRX007), titled “METHODS AND SYSTEMS FOR SHARING PARTNERSHIP DATA IN SHIPPING TRANSACTIONS,” and (Attorney Docket No. 1402872.00009_TRX009), titled “METHODS AND SYSTEMS FOR TRACKING ASSETS OF SHIPPING TRANSACTIONS IN REAL TIME,” each of which are filed concurrently herewith, and the entire contents and substance of all of which are hereby incorporated in total by reference in their entireties and for all purposes.

### TECHNICAL FIELD

The subject matter disclosed herein generally relates to processing data. In some example embodiments, the present disclosures relate to systems and methods for facilitating shipping transactions using a virtual dashboard interface.

### BACKGROUND

In shipping transactions, particularly in a shipping supply chain of the trucking industry, generally, multiple distinct parties may be involved to complete a shipping transaction. The multiple parties are generally categorized as one of a shipper, receiver, broker and carrier. Conventionally, there are many companies that can be categorized into each of these different types of parties, unlike the parcel shipping business where there are only a few major companies (e.g., FedEx, UPS, US Postal Service, etc.). Coordinating the many different types of parties, and the many entities categorized within each party, has typically been conducted manually and without complete information. In addition, it is desirable to utilize the plethora of information through an efficient graphical user interface. In general, the trucking industry has a long-standing need for improved organization, logistics, and transparency.

### BRIEF SUMMARY

Aspects of the present disclosure provide a uniquely designed digital interface including multiple dashboards to offer complete visibility to the users of freight companies with any business role in the logistics industry. In some embodiments, a freight management system for improving logistics in shipping transactions is presented. The system may include: at least one memory; at least one processor coupled to the at least one memory, and configured to: cause display of a graphical dashboard user interface of the freight management system, the graphical dashboard user interface comprising: a centralized console display configured to display statuses of a plurality of shipping transactions, the statuses including a regularly updating current location status for each of the plurality of shipping transactions; a reports display configured to receive inputs for generating reports of pending and completed shipping transactions; a map display configured to display a live update of a route, overlaid on a map, of a selected shipping transaction among the plurality of shipping transactions; and an administration menu comprising an asset management page, a user management page, a contacts management page, a partnership management page, and an alarm management page; wherein the administration menu is configured to receive inputs to control privileges and display settings of the centralized console display, the reports display, and the map display.

In some embodiments of the system, the centralized console display is further configured to: receive a cursor input placed over a status of a shipping transaction among the plurality of shipping transactions; and in response, cause display of a floating window overlaid on the console display and displaying additional information about the shipping transaction.

In some embodiments of the system, the statuses further comprise an order number, a pickup date, a driver name, an origin city, a destination city, a commodity type, a purchase order identifier, a receiver purchase order identifier, a delivery date, a payment value, and a load status identifier.

In some embodiments of the system, the graphical dashboard user interface further comprises a filter application configured to filter displays of the statuses of the plurality of shipping transactions in the centralized console display, based on one or more of the statuses.

In some embodiments of the system, the filter application is configured to filter displays of the statuses based further on current location of the shipping transactions, and partnerships formed with freight companies associated with the shipping transactions.

In some embodiments of the system, the filter application is configured to filter displays of the statuses based further on one or more load status identifiers, the load status identifiers comprising: an “available” status, a “booked” status, a “dispatched” status, a “loading” status, a “loaded” status, an “unloading” status, an “empty” status, a “settled” status, a “partial” status, a “void” status, and an “outside” status.

In some embodiments of the system, the graphical dashboard user interface is further configured to generate pre-selected filters for filtering the statuses of the plurality of shipping transactions, using the filter application.

In some embodiments of the system, the graphical dashboard user interface is further configured to cause display a first version of the centralized console display and a second version of the centralized console display concurrently; wherein the first version of the centralized console display includes statuses of the plurality of shipping transactions filtered by a first filter using the filter application, and the second version of the centralized console display includes statuses of the plurality of shipping transaction filtered by a second filter using the filter application.

In some embodiments of the system, the graphical dashboard user interface is further configured to provide live updates to both the first version and second version of the centralized console display, and display updated statuses only of those that pass through the respective first and second filters.

In some embodiments of the system, the reports comprise summarized information of a total number of shipping transactions among the plurality of shipping transactions, the summarized information including, regarding the shipping transactions among the total number of shipping transactions: a unique number of shippers, a unique number of receivers, a unique number of brokers, a unique number of carriers, a unique number of recipients billed to, a unique number of recipients paid to, a total amount billed, an average amount billed, a total amount paid, an average amount paid, a total amount of profit, and an average amount of profit.

In some embodiments of the system, the summarized information further includes, regarding the shipping transactions among the total number of shipping transactions: a total number of shipping pick ups, an average number of pick ups per shipment, a number of on-time pick ups, a percentage of on-time pick ups, a total number of shipping drop offs, an average number of drop offs per shipment, a number of on-time drop offs, and a percentage of on-time drop offs.

In some embodiments of the system, the reports display is further configured to: receive a cursor input placed over one item of the summarized information; and in response, cause display of an enumerated list of shipping transactions tabulated within the one item of summarized information.

In some embodiments of the system, the asset management page of the administrative menu comprises information about a shipping asset, including: whether the asset is a tractor or a trailer, whether the asset is active, equipment type for storing shipping products, and unique identification information of the asset.

In some embodiments of the system, the inputs to control the privileges and display settings of the centralized console display, the reports display, and the map display comprise inputs to allow users to: view order financials, customize order alarms, customize order sharing, acknowledge order flags, view outside orders, and settle orders.

In some embodiments of the system, the inputs to control the privileges and display settings of the centralized console display, the reports display, and the map display comprise inputs to allow users to manually edit: private contact entries, shipper order fields, receiver order fields, carrier order fields, bill to order fields, and pay to order fields.

In some embodiments of the system, the contacts management page is configured to display public contacts available in a public shipping database, and display private contacts not available in the public shipping database.

In some embodiments of the system, the contacts management page is configured to display information of a single contact, including personnel information, shipping license information, geographic location information expressed in a map display view, and a geofencing radius for specifying an area in which the contact is able to provide shipping services to.

In some embodiments of the system, the alarm management page is configured to activate an alarm that alerts a user to a trigger condition related to a measure of performance during a shipping transaction.

In some embodiments, a graphical dashboard user interface of a freight management system operated by at least one memory and at least one processor of the freight management system is presented. The user interface may include: a centralized console display configured to display statuses of a plurality of shipping transactions, the statuses including a regularly updating current location status for each of the plurality of shipping transactions; a reports display configured to receive inputs for generating reports of pending and completed shipping transactions; a map display configured to display a live update of a route, overlaid on a map, of an elected shipping transaction among the plurality of shipping transactions; and an administration menu comprising an asset management page, a user management page, a contacts management page, a partnership management page, and an alarm management page; wherein the administration menu is configured to receive inputs to control privileges and display settings of the centralized console display, the reports display, and the map display.

In some embodiments, a computer-readable medium is presented having no transitory signals and embodying instructions that, when executed by a processor, perform operations comprising: causing display of a graphical dashboard user interface of the freight management system, the graphical dashboard user interface comprising: a centralized console display configured to display statuses of a plurality of shipping transactions, the statuses including a regularly updating current location status for each of the plurality of shipping transactions; a reports display configured to receive inputs for generating reports of pending and completed shipping transactions; a map display configured to display a live update of a route, overlaid on a map, of a selected shipping transaction among the plurality of shipping transactions; and an administration menu comprising an asset management page, a user management page, a contacts management page, a partnership management page, and an alarm management page; wherein the administration menu is configured to receive inputs to control privileges and display settings of the centralized console display, the reports display, and the map display.

### BRIEF DESCRIPTION OF THE DRAWINGS

Some embodiments are illustrated by way of example and not limitation in the figures of the accompanying drawings.

FIG. 1 is a network diagram illustrating an example network environment suitable for aspects of the present disclosure, according to some example embodiments.

FIG. 2 shows a first graphical display of the Application View of the dashboard, according to some embodiments.

FIG. 3 shows an example of how the personalized dashboard view also may include a distinctive tooltip-style floating window to quickly display additional information by hovering over any grid data item, according to some embodiments.

FIG. 4 shows an example of how the personalized dashboard view (and throughout the website) offers exhaustive filtering dialog to customize the view in any possible way including, for example, rolling date ranges to meet the user's objectives.

FIG. 5 shows an example of how customized filter tags can be selected in a menu.

FIG. 6 provides an example of what different filters are applied when the personalized dashboard view is shown in two or more different browser tabs, according to some embodiments.

FIG. 7 shows the two different pages in the tabs of FIG. 6.

FIG. 8 shows a Reports menu that provides another very flexible way to obtain business perspectives on orders with drill down features, according to some embodiments.

FIG. 9 shows available pre-canned reports to be selected from the drop down.

FIG. 10 shows an example of a General Summary report as previously described in FIGS. 8 and 9.

FIG. 11 shows an example of a General Summary by Carrier report as previously described in FIGS. 8 and 9.

FIG. 12 shows additional features of the Application View in the dashboard, according to some embodiments.

FIG. 13 shows a display for Manage Assets, which is for setting company-level asset configurations, according to some embodiments.

FIG. 14 shows a detailed user property view from the Manage Users tab, where the company administrator user can control a normal user's behavior for security or business practice reasons.

FIG. 15 shows the main page for the Manage Contacts, which is for company-level contact management, when selected to show public contacts.

FIG. 16 shows that the public or private detail contact page contains a location map for easy lookup and surrounding assessment.

FIG. 17 shows changing options when selected to show private contacts compared to FIG. 15, according to some embodiments.

FIG. 18 shows user-level contact management available to normal users from the Application View.

FIGS. 19A and 19B illustrate features of My Company Public contact in the Administration View's Manage Contacts tab.

FIGS. 20A and 20B show the Manage Alarms tab, according to some embodiments.

FIG. 21 shows the App Customization tab, according to some embodiments.

FIG. 22 shows various account preferences, based on the App Customization tab.

FIG. 23 is a block diagram illustrating components of a machine, according to some example embodiments, able to read instructions from a machine-readable medium and perform any one or more of the methodologies discussed herein.

### DETAILED DESCRIPTION

Example methods, apparatuses, and systems (e.g., machines) are presented for a dashboard interface to facilitate shipping transactions between multiple parties in a supply chain for providing products to consumers. Generally, multiple distinct parties may be involved to complete a shipping transaction, such as a shipment of bottles of wine from a winery to a marketplace, such as a grocery store. The multiple parties are generally categorized as one of a shipper (e.g., the winery), receiver (e.g., the grocery store), broker (e.g., third party middle man helping to coordinate contacts with the parties) and carrier (e.g., truck or trucking company). Conventionally, there are many companies that can be categorized into each of these different types of parties, unlike the parcel shipping business where there are only a few major companies (e.g., FedEx, UPS, US Postal Service, etc.). For example, there are many small freight businesses, where private contractors simply may offer their resources, e.g., their truck(s), whenever and wherever they may be available. It is desirable to provide a common interface for all of these parties involved in the shipping transaction to interact and communicate with one another, as well as be able to view the status of shipped products from each of their perspectives.

Aspects of the present disclosure provide a uniquely designed digital interface including multiple dashboards to offer complete visibility to the users of freight companies with any business role in the logistics industry. For example, an Application View and an Administration View are provided in the digital dashboard interface that allows users to access their information related to one or more shipping transactions. In some embodiments, in the Application View, the Shipper, Broker, Carrier or Receiver can access an order-centric dashboard via a personalized dashboard view and location (e.g., map)-centric dashboard via a Map menu. From context sensitive links from the personalized dashboard view, for a specific order, the user can check detailed order element information in an Order Entry page and detailed location tracking and product integrity information in a Track Order page. Also, a Reports menu provides ways to generate pre-canned reports for any filtered and/or selected orders, and a Contact menu offers user-level private contact management and public contact lookups. Meanwhile, in the Administration View, according to some embodiments, the users with administrative privileges can manage company-level settings for assets, users, contacts, partnerships, alarms and application properties to streamline the Application View's feature behaviors and user experience tailored for the company's business practice.

In some embodiments, the Application View and the Administration View which can be toggled through a button or setting, such as by a top menu link “Switch To.” In some embodiments, each view has its own submenus, as the Administration View can be only accessible for the users with administrator privileges to control assets, users, contacts, partnerships, alarms and application behaviors, while the Application View can be accessible for the normal users who can view more commonly accessible information, such as the customized order summary dashboard, detailed order element and tracking information, order and asset map views, and reports, create an order entry, and manage user level contacts.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

The following definitions may be used herein.

Freight management system: Main freight management website, including an administrative freight management website, installation phone utility application, freight management software services, freight management tracker hardware and software subsystems.

The freight management system of the present disclosures brings a revolutionary logistics business facilitation and modernization platform that utilizes social network software aspects for intricacy of trucking load processing and cellular communication network with GPS and monitoring sensors for product integrity information.

Freight management company: a company which signed up for the freight management website. The freight management company may have one or more roles typical in the trucking industry, described more below.

Freight management user: a user under a signed-up freight management company. The freight management company can have multiple users.

Freight management company roles follow the business entities in the trucking supply chain/logistics, which are Shipper, Receiver, Broker and Carrier. A shipper generally is defined as an entity that has goods to be moved to a receiver, such as a manufacturer of goods. A receiver generally is defined as an entity that is designated to receive goods from a shipper, such as a retail store or grocery store. A carrier generally is defined as an entity designated to pick up a shipment of goods and transport said goods to a designated location. The carrier generally is in control of shipping assets, like one or more trucks (e.g., 18 wheelers). A carrier may be a single individual who owns a truck and uses his truck to pick up and transport goods, or may be a larger organization that controls a fleet of trucks and drivers. While some companies have integrated solutions and include carrier functionality for its shipping or receiving operations, it is often the case that the shipper, carrier, and receiver are distinct and separate entities. A broker generally is defined as a coordinator to facilitate the completion of the shipping supply chain between the shipper, carrier, and receiver. A broker may be responsible for contacting various carriers to fulfill shipping and receiving needs, for example.

Freight management company can identify itself and utilize the freight management system as one or multiples of business roles where the freight management website provides unprecedented visibility to the freight management companies.

Partnership: freight management companies can establish partnerships amongst themselves to benefit each other in the business practice to facilitate their own operations.

Contact: There are three types of contacts—public (from e.g., FMCSA database), private (e.g., Freight management company maintained from public contacts) and my company public (e.g., company's public list compilation if it has multiple locations).

Asset: A freight management tracker attached trailer or tractor of the truck.

Order: A freight management order is a work order or shipping/delivery load which encompasses all the necessary information to move goods from A to B including pickups, deliveries, carrier, tracking, requirement, sharing, equipment, driver, finance information, product integrity information such as temperature, speed and more.

Order has eight status including AVL (available), BKD (booked), DIS (dispatched), LDG (loading), LDD (loaded), ULD (unloading), MT (empty) and STL (settled). Other statuses readily apparent to those with ordinary skill in the art are also possible, and embodiments are not so limited.

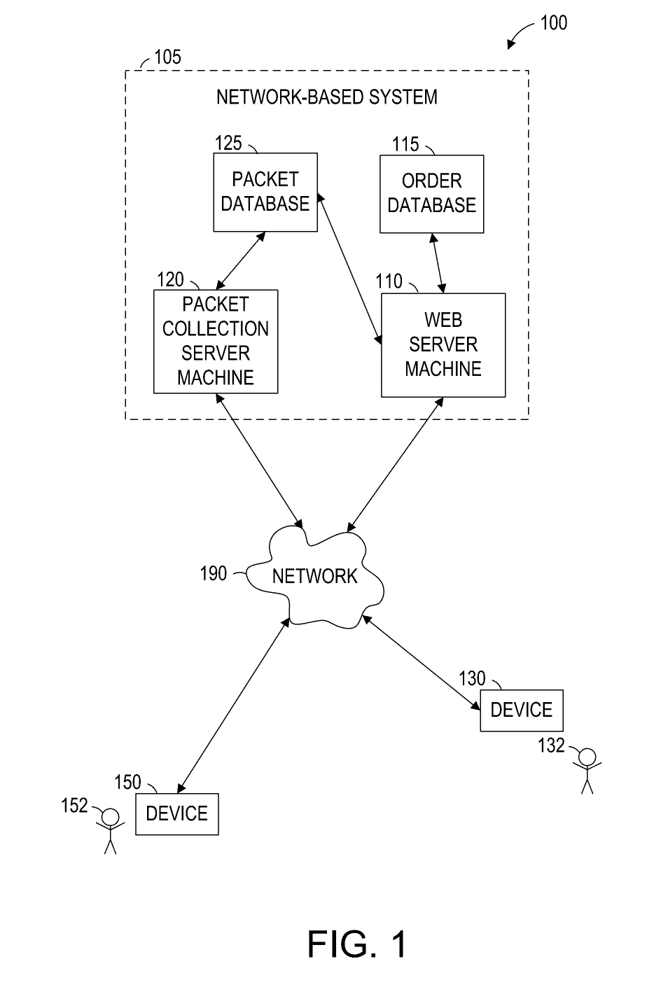

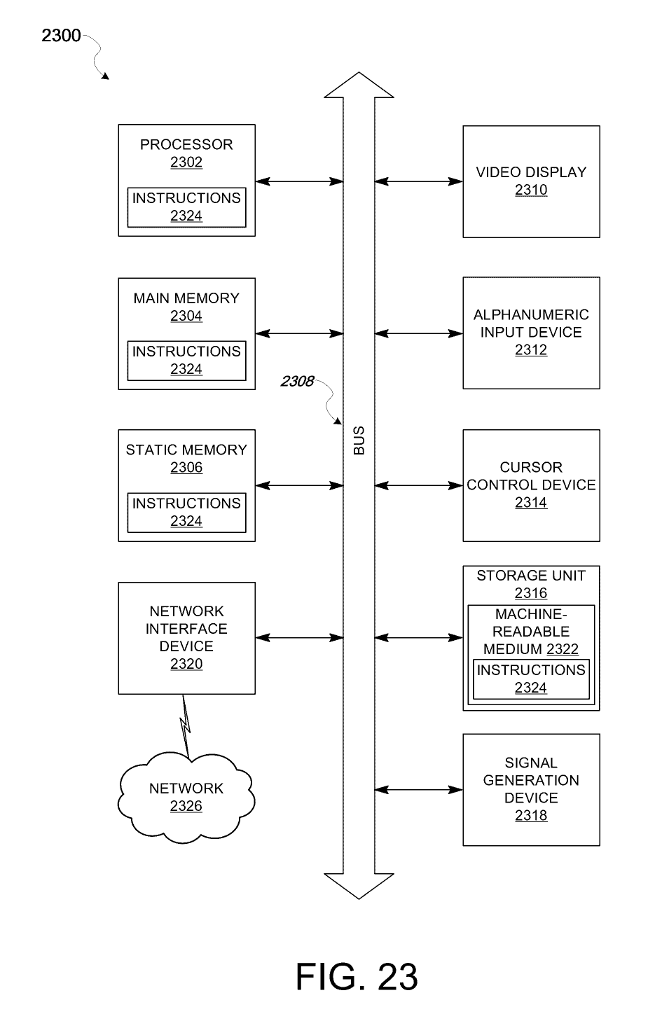

Referring to FIG. 1, a network diagram illustrating an example network environment 100 suitable for performing aspects of the present disclosure is shown, according to some example embodiments. The example network environment 100 includes a web server machine 110, an order database 115, a packet collection server machine 120, a packet database 125, a first device 130 for a first user 132, and a second device 150 for a second user 152, wherein the server machines 110 and 120 are communicatively coupled to the devices 130 and 150 via a network 190. In some embodiments, either or both of the web server machine 110 and packet collection server machine 120 may form all or part of a network-based system 105 (e.g., a cloud-based server system configured to provide one or more services to the first and second devices 130 and 150). The web server machine 110, the packet collection server machine 120, the first device 130, and the second device 150 may each be implemented in a computer system, in whole or in part, as described below with respect to FIG. 23. Through this example configuration of the network-based system 105, aspects of the present disclosure may be configured to enable either of the devices 130 or 150 to track information derived from the other device 150 or 130, as well as track any web interface devices, such as if device 130 or 150 operates as a web interface device. In other words, the devices 130 and 150 may be configured to interface with the system of the present disclosures, as well as with other devices, through both a web-based interface and through an app-based interface.

Also shown in FIG. 1 are the first user 132 and the second user 152. One or both of the first and second users 132 and 152 may be a human user, a machine user (e.g., a computer configured by a software program to interact with the first device 130), or any suitable combination thereof (e.g., a human assisted by a machine or a machine supervised by a human). The first user 132 may be associated with the first device 130 and may be a user of the first device 130. For example, the first device 130 may be a desktop computer, a vehicle computer, a tablet computer, a navigational device, a location tracking device, a monitoring sensor data collecting device, a portable media device, a smartphone, or a wearable device (e.g., a smart watch or smart glasses) belonging to the first user 132. Likewise, the second user 152 may be associated with the second device 150. As an example, the second device 150 may be a desktop computer, a vehicle computer, a tablet computer, a navigational device, a location tracking device, a monitoring sensor data collecting device, a portable media device, a smartphone, or a wearable device (e.g., a smart watch or smart glasses) belonging to the second user 152. Other devices, not shown, may also be configured to interface with the network-based server 105 similar to devices 130 and 150, and embodiments are not so limited. For example, the first device 130 may be operated by a shipper, the second device 150 may be operated by a carrier, a third device may be operated by a broker, and a fourth device may be operated by a receiver, all of which may be configured to transmit and receive information about a shipping transaction from each other device.

Any of the machines 110 and 120, databases 115 and 125, or first or second devices 130 or 150 shown in FIG. 1 may be implemented in a general-purpose computer modified (e.g., configured or programmed) by software (e.g., one or more software modules) to be a special-purpose computer to perform one or more of the functions described herein for that machine 110 or 120, database 115 or 125, or first or second device 130 or 150. For example, a computer system able to implement any one or more of the methodologies described herein is discussed below with respect to FIG. 23. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines 110 and 120, databases 115 and 125, and devices 130 and 150. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

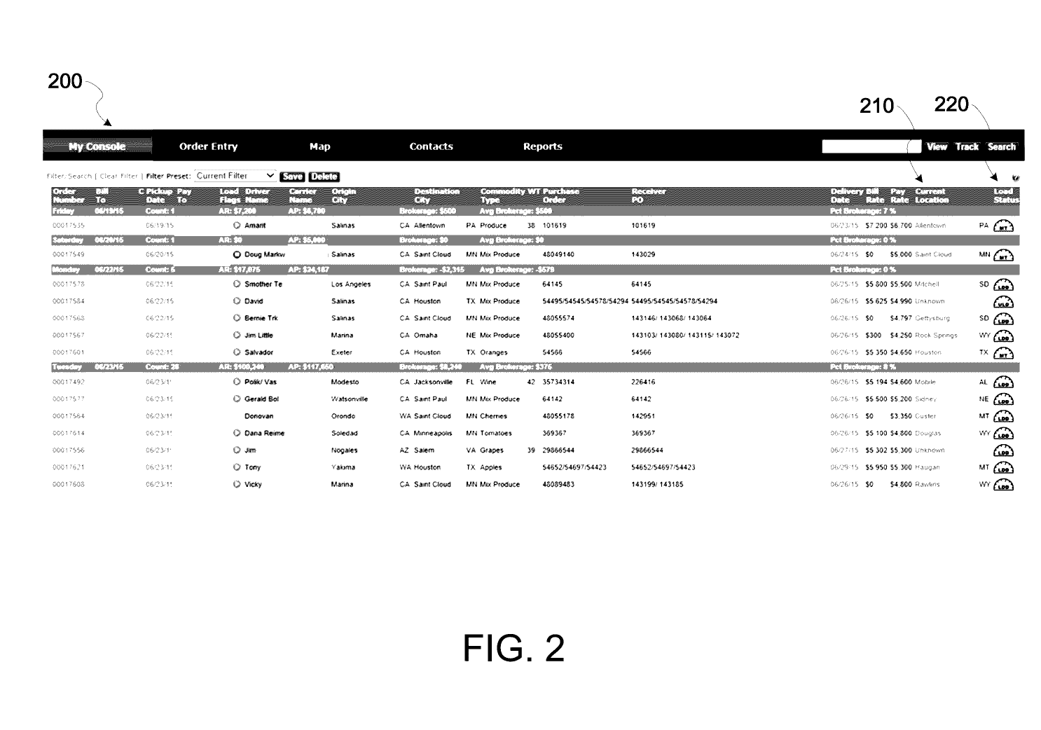

Referring to FIG. 2, illustration 200 shows a first graphical display of the Application View, according to some embodiments. Shown here is the personalized dashboard view (shown here under the “My Console” tab), which provides an innovative dashboard view of an order list available to the user with a configurable update interval. Users of this dashboard may include a freight company user in any of the roles of shipper, carrier, receiver, or broker. The dashboard in illustration 200 can act as a “central command” view of all orders currently underway and what their statuses may be. The dashboard view can show up to date snapshots of order progress such as the location or order status advances. For example, the “Current Location” label 210 provides an up to date status of where a shipment is along its route. The design of the dashboard view enables the user to grasp comprehensive information about the status of orders at a glance with easy to understand color and graphics schemes while offering context sensitive links to more specific information, such as the Order Entry (from order number and pickup or delivery date fields) or Track Order pages (from current location field) for detailed drill down information. The personalized dashboard view also includes the work of partnerships formed between the various freight companies as it may be configured to refresh to show any filtered-in partner companies' orders whenever they are being generated. For example, if Freight company A has a “View Orders” partnership with Freight company B, then, as soon as (or after configurable delay) an order from Freight company B is available, it will show up in Freight company A's personalized dashboard view. Discussion of partnerships is further described in US Non-provisional Application (Attorney Docket No. 1402872.00007), which is incorporated herein by reference.

The information displayed in the dashboard of illustration 200 may be provided by one or more databases of the freight management system, such as order database 115 in network-based system 105. In some cases, the network-based system is configured to continually receive updated information, as well as update this information in the dashboard. For example, the “Current Location” status 210 may be continually updated using live-tracking techniques of the freight management system. The “Load Status” indicator 220 may also be updated live. Examples for conducting this process are described further in US Non-provisional Application (Attorney Docket No. 1402872.00009), which is incorporated herein by reference.

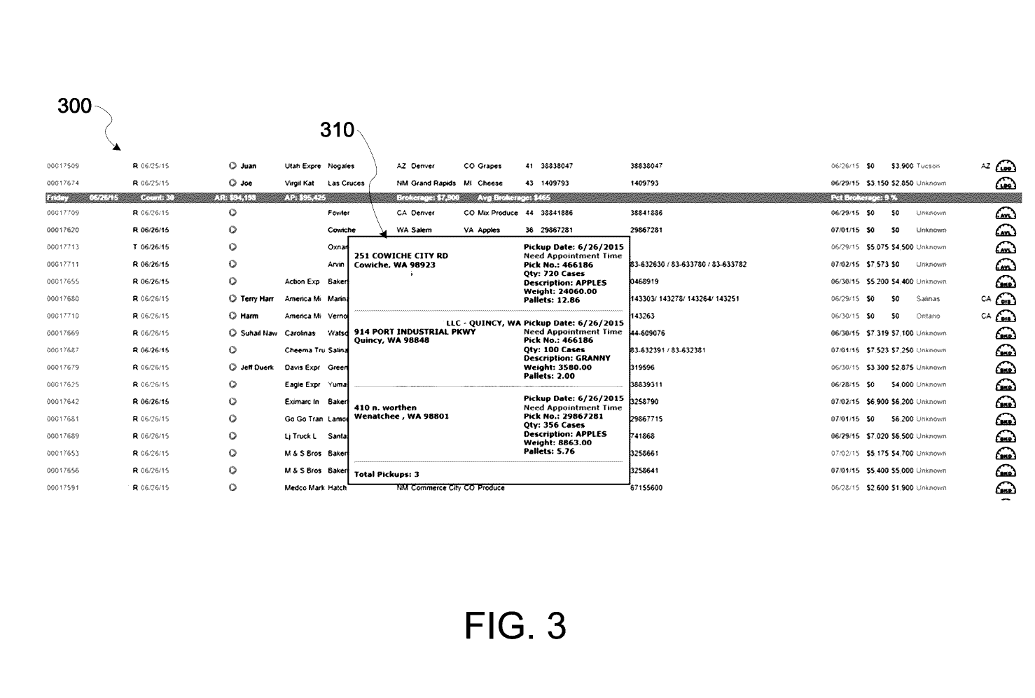

Referring to FIG. 3, illustration 300 shows an example of how the personalized dashboard view also may include a distinctive tooltip-style floating window 310 to quickly display additional information by hovering over any grid data item, according to some embodiments. Note that the data may be retrieved on the fly via a web service interface instead of pre-loading for up to date information and less processing up front.

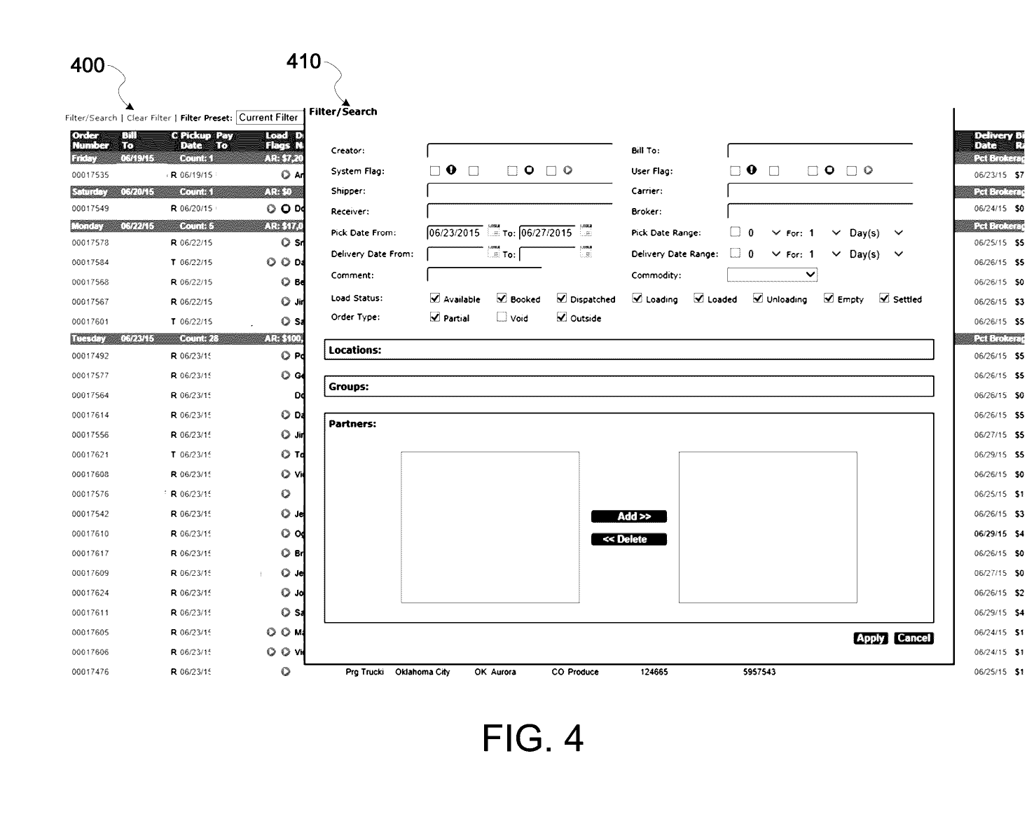

Referring to FIG. 4, illustration 400 shows an example of how the personalized dashboard view (and throughout the website) offers exhaustive filtering dialog 410 to customize the view in any possible way including, for example, rolling date ranges to meet the user's objectives. Furthermore, any user defined filters can be saved and reused through a drop down list. These options may allow for the many status indicators of each shipping transaction to be distilled into more readily consumable bits of information. Notice that example filters include name of shipper, carrier, receiver, or broker; various system flag statuses; name of creator of the order entry and who to bill to; date ranges for delivery and pick up; load statuses, locations; pre-generated groups; and partnerships formed by the user. Other types of filters, based on any of the information displayable in the dashboard, may be utilized, and embodiments are not so limited.

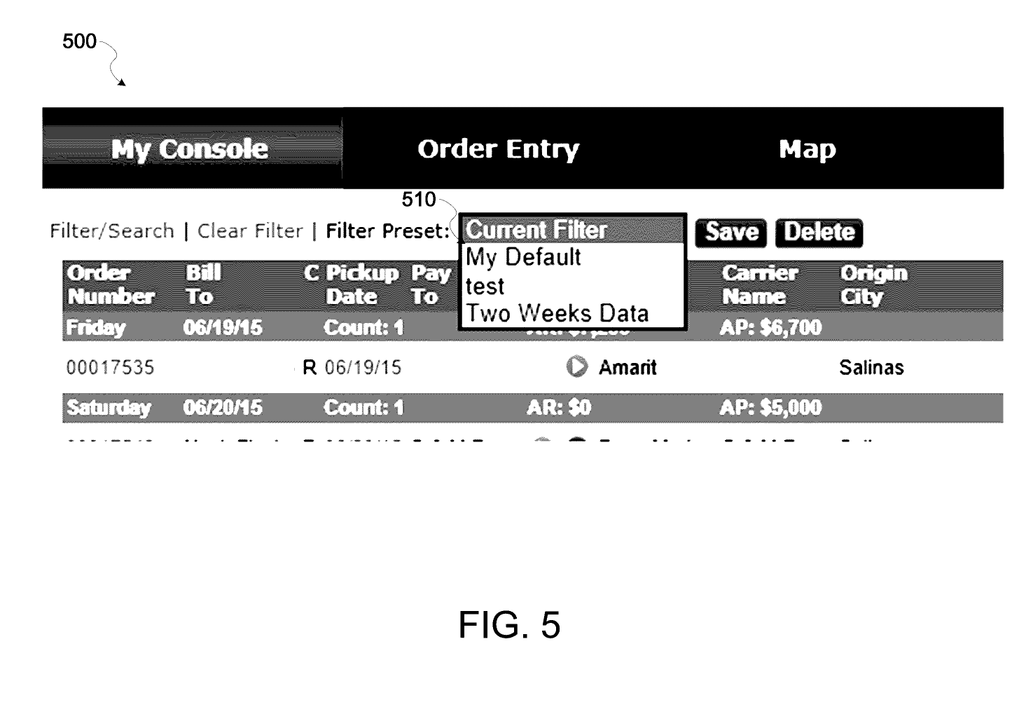

Referring to FIG. 5, illustration 500 shows an example of how customized filter tags can be selected in a menu 510. The various settings of previously used filters may be saved so that the filter may be used over again.

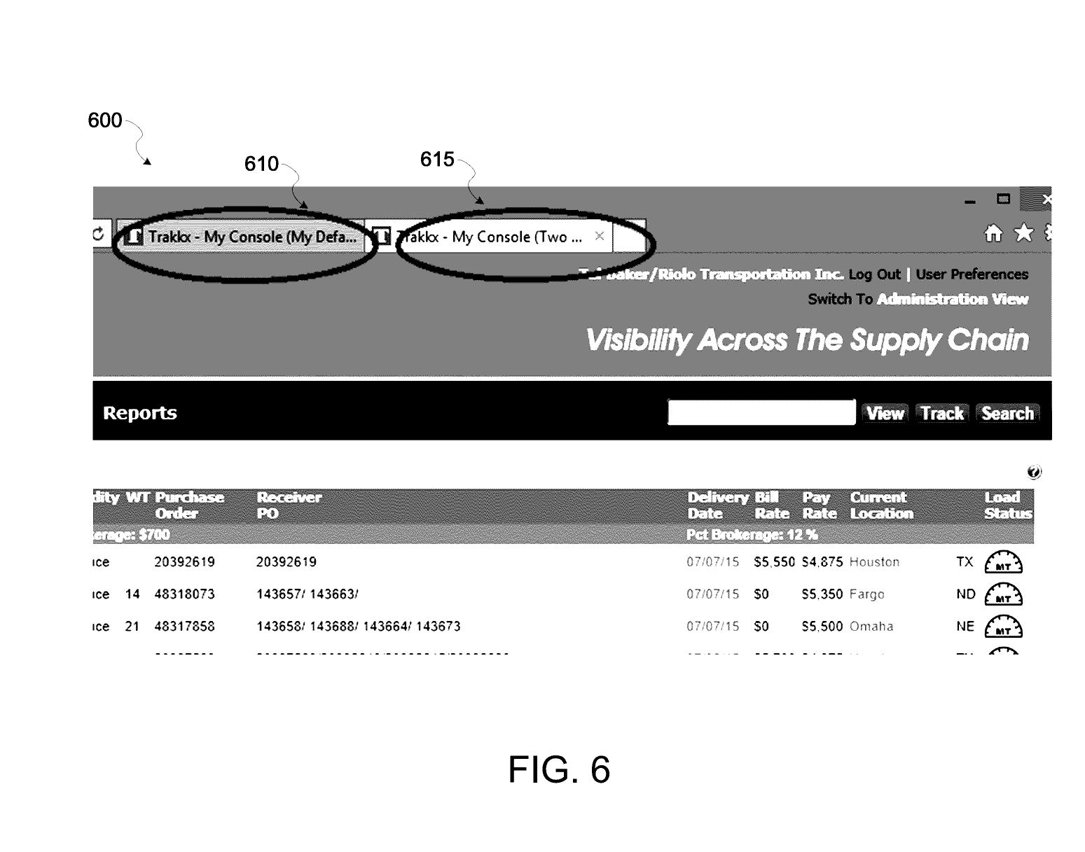

Referring to FIG. 6, illustration 600 provides an example of what different filters are applied when the personalized dashboard view is shown in two or more different browser tabs, 610, and 615, according to some embodiments. For example, the personalized dashboard view cleverly utilizes modern browsers' multi-tab/window capability to display views with different filter options in tabbed or separate windows. Most commonly for normal websites, during one session, tabbed or separate browser windows can momentarily show different data but eventually data displaying is synced up on refreshing or other data changing events. However, tabbed or separate personalized dashboard view browser windows can hold its own applied filtering option to enable the user to view multiple filtered views. This is particularly useful with a multi-monitor environment as the user can set one monitor to show, for example, all the orders related to certain partner or time period, while another monitor to show urgent order list or different time period, etc. This user experience can be further enhanced by utilizing the above filter saving feature to permanently save an applied filter for reuse.

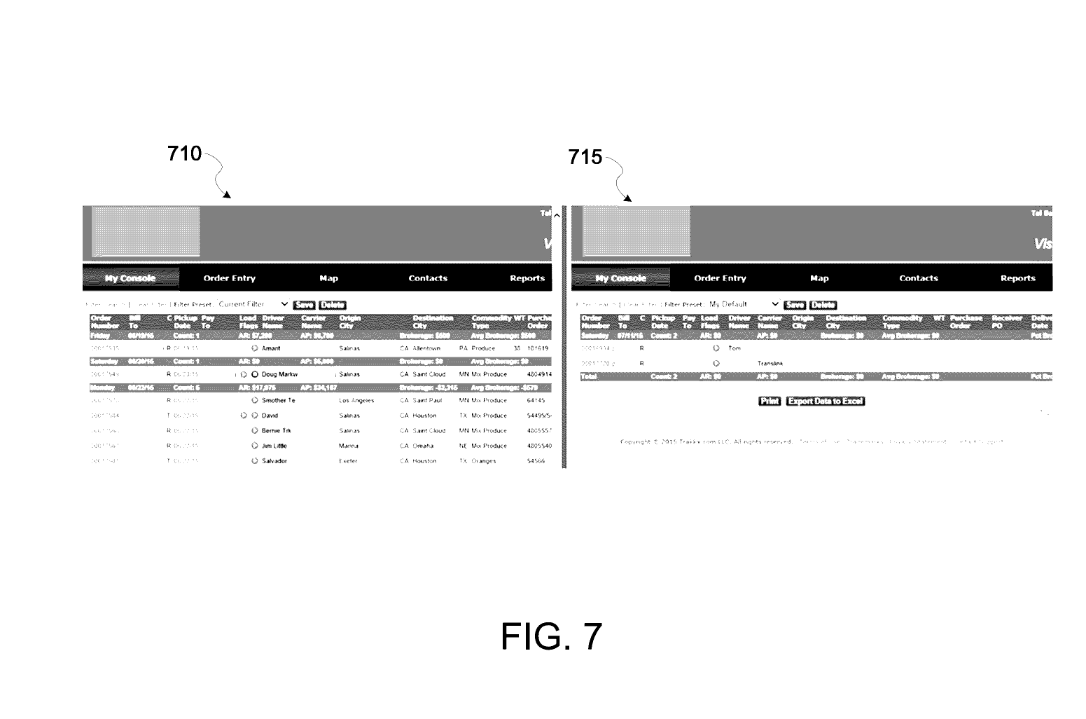

FIG. 7 shows the two pages 710 and 715 in the tabs 610 and 615, respectively, of FIG. 6. As shown, a different filter is applied in each page, resulting in different sets of information being shown from the same set of orders.

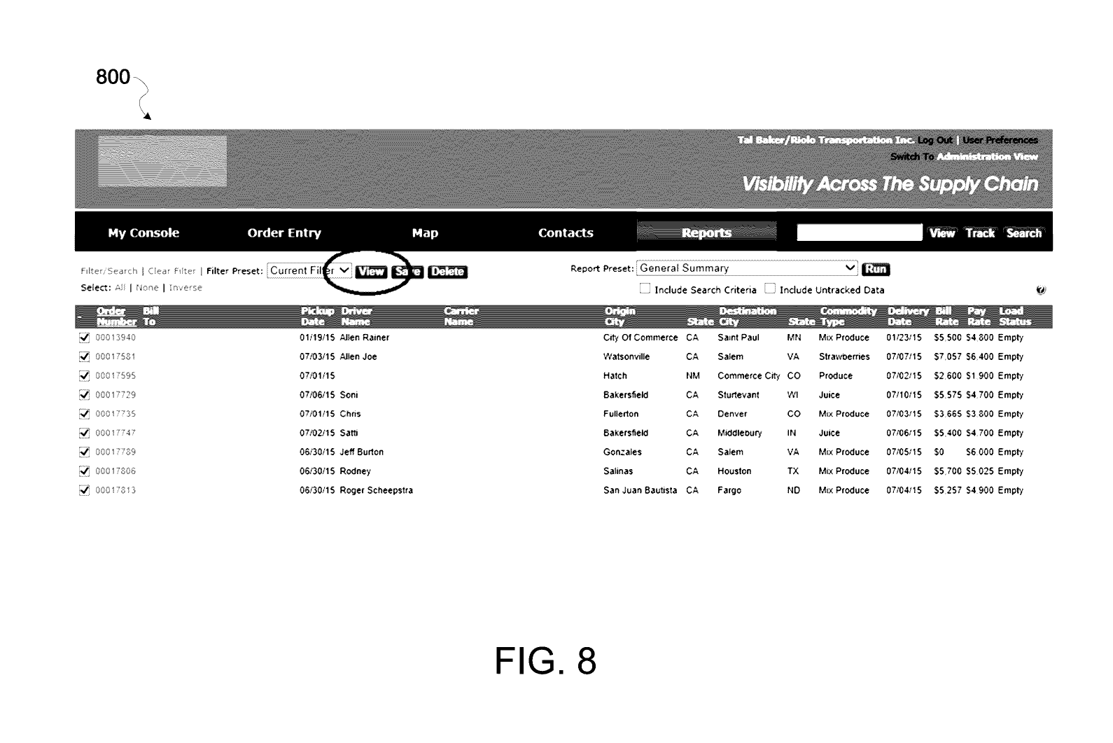

Referring to FIG. 8, a Reports menu tab provides another very flexible way to obtain business perspectives on orders with drill down features, according to some embodiments. As with the personalized dashboard view described in the previous figures, the user can set any filter to view orders. The reports keep track of orders that are already fulfilled or otherwise resolved, as opposed to the order entry tab that tracks live orders.

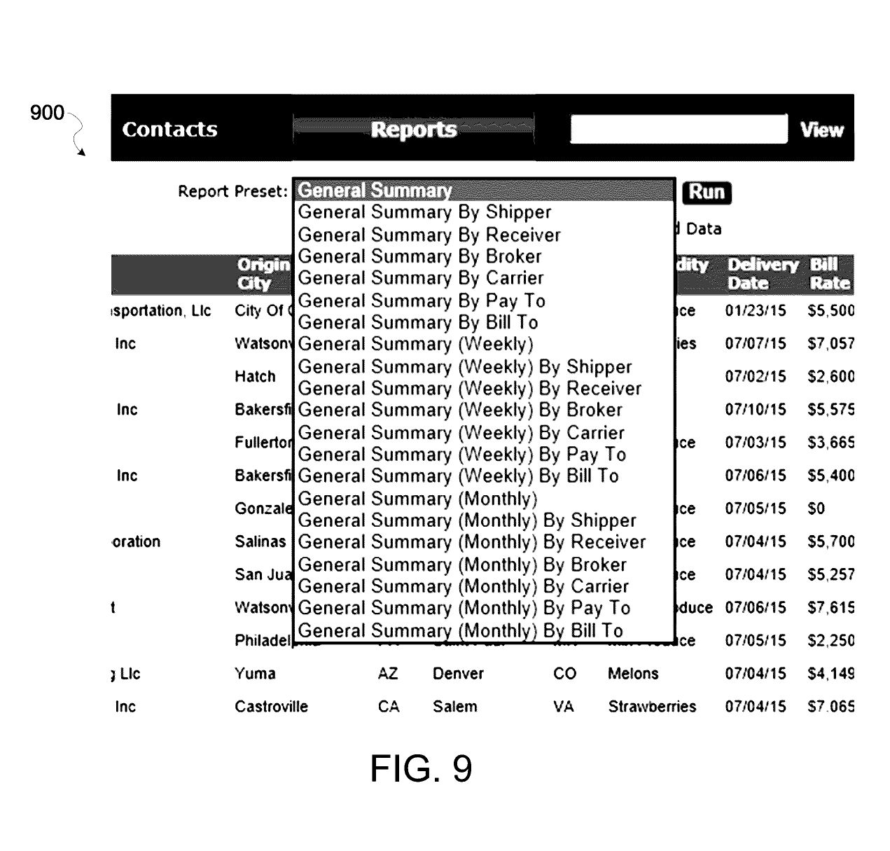

Referring to FIG. 9, once a filter is set to view orders as described in FIG. 8, a Reports menu 900 indicates that a pre-canned report can be generated from the drop down options, according to some embodiments. For example, for a given filter, a General Summary report may be generated that sums up business metric calculations, or a General Summary By Carrier report may be generated that is focused on statistics for each carrier involved. Note that in some cases, reports can be generated without proceeding to the viewing orders step, but the user can further filter out for only interested orders after selecting the inclusion/exclusion checkbox.

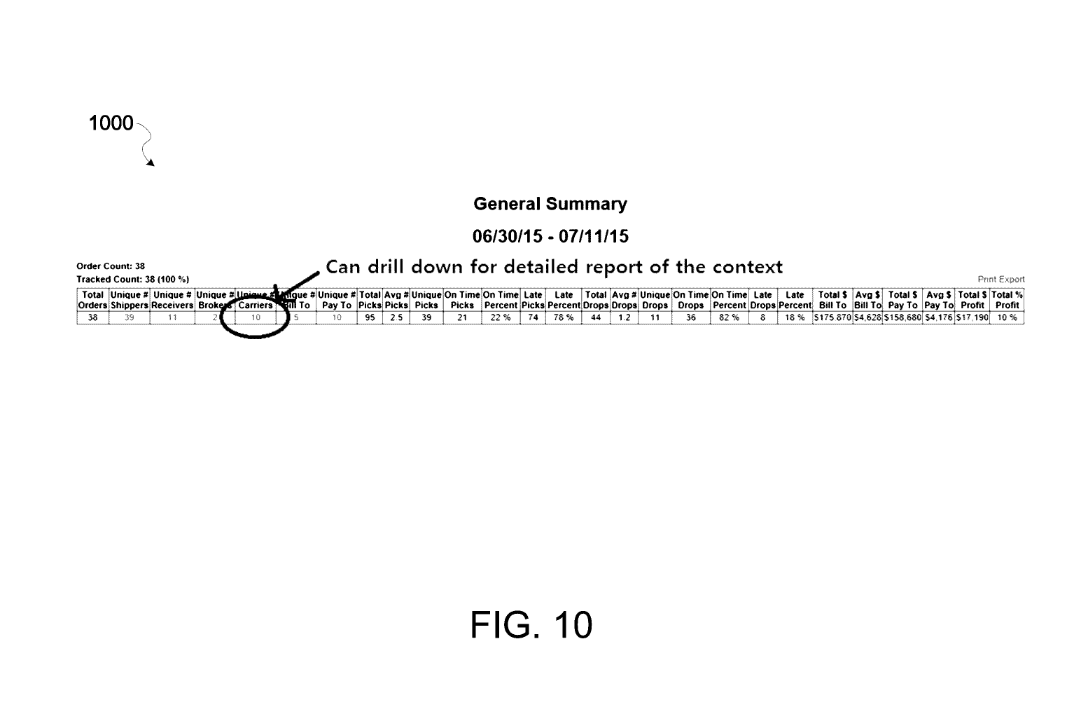

Referring to FIG. 10, an example of a General Summary report 1000 is shown, as previously described in FIGS. 8 and 9. As shown, any selected item in the report may result in further details provided and displayed. For example, for a unique number of shippers shown to be 10, selecting on this item may result in all 10 unique shippers enumerated, as well as other information about them, such as principle places of business, lead contact, whether they are in partnership with the user, and other types of information.

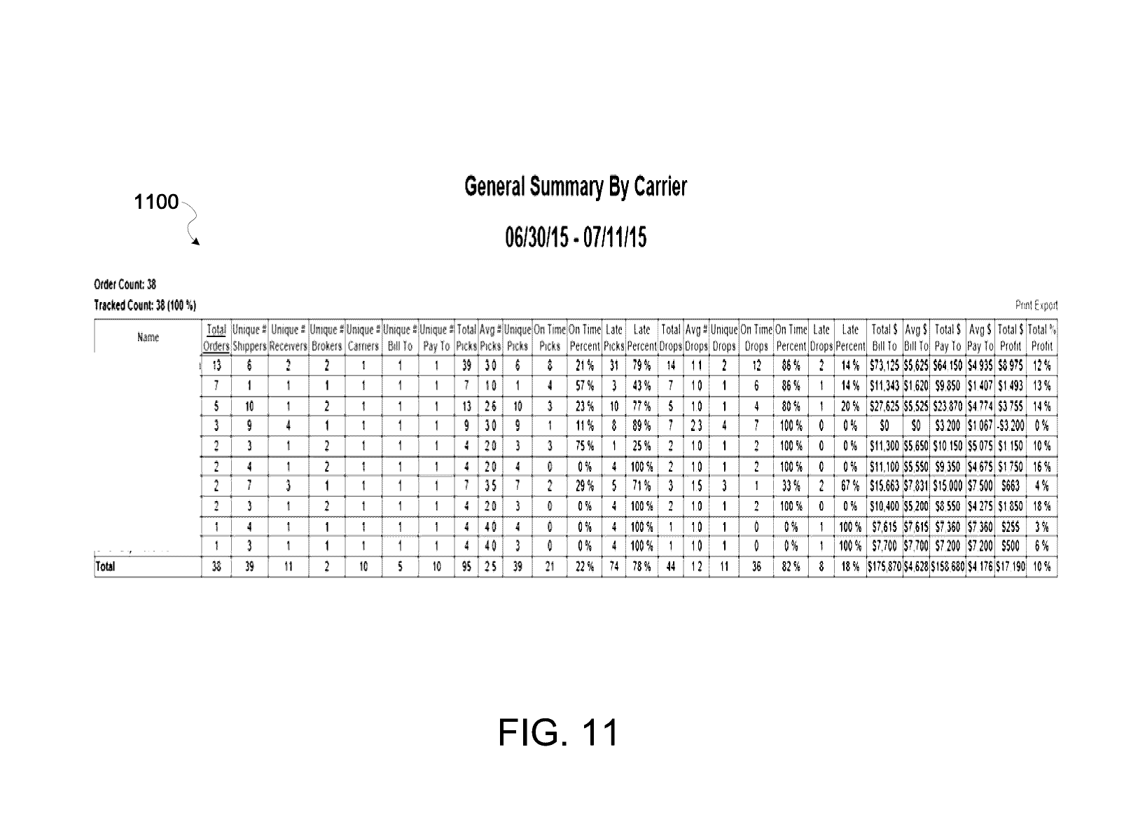

Referring to FIG. 11, an example of a General Summary by Carrier report 1100 is shown, as previously described in FIGS. 8 and 9.

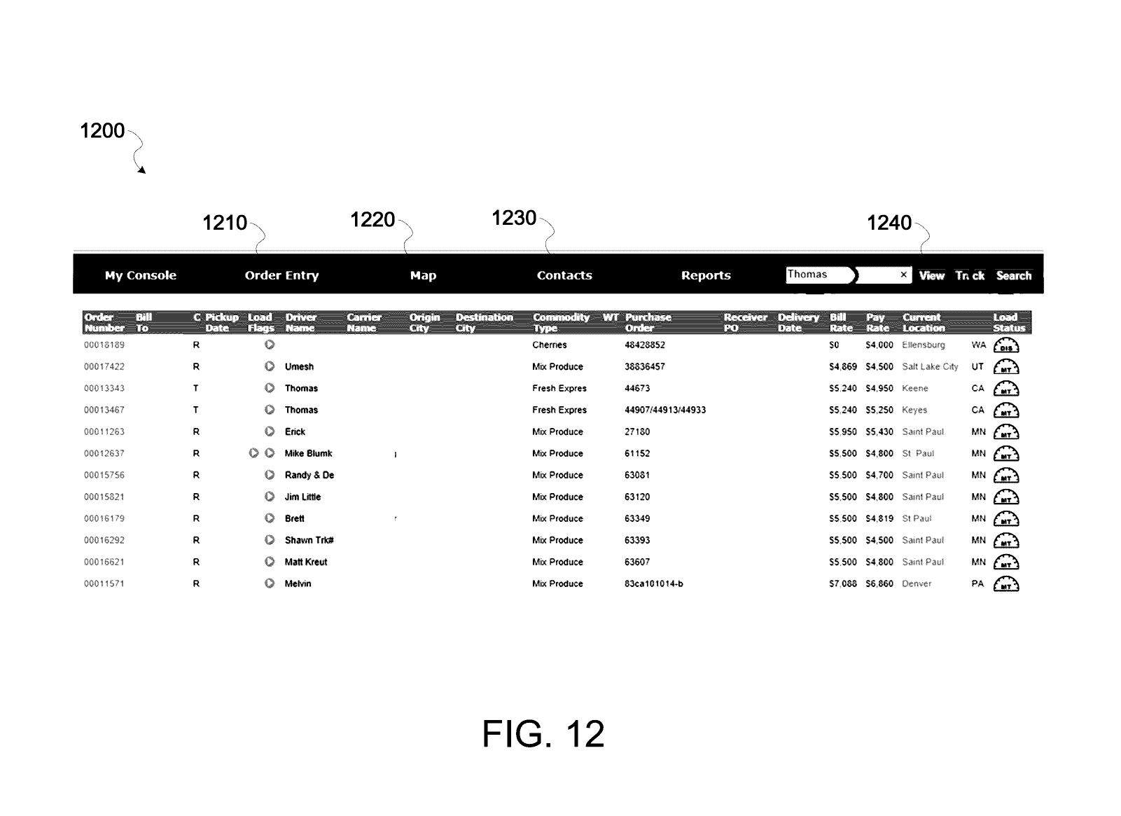

Referring to FIG. 12, illustration 1200 shows additional features of the Application View in the dashboard, according to some embodiments. For example, the Order Entry menu tab 1210 is available to create a new order. Further details were explained in the previous figures. As another example, the Map menu tab 1220 provides a location tracking based dashboard either in the perspective of orders or assets (e.g., trucks carrying cargo). Additional details of this are described along with the Track Order page in US Non-provisional Application (Attorney Docket No. 1402872.00009_TRX009), which is again incorporated herein by reference.

As another example, the Contact menu tab 1230 is for normal user-level private contact management and public contact referencing. This is of the similar format as in Administration View, which will be introduced with more detail below.

As another example, the View/Track/Search option 1240 is located at upper-right side of Application View, according to some embodiments, and offers an easy search feature for entire orders. A typical usage scenario is to type in an order number and use the View button to directly access the detailed Order Entry page or Track button to Track Order page. Also, the user can search orders with a general phrase by using the Search button. If there is a unique match, it will take the user directly to the detailed Order Entry page as well. Otherwise, it returns a possible result list.

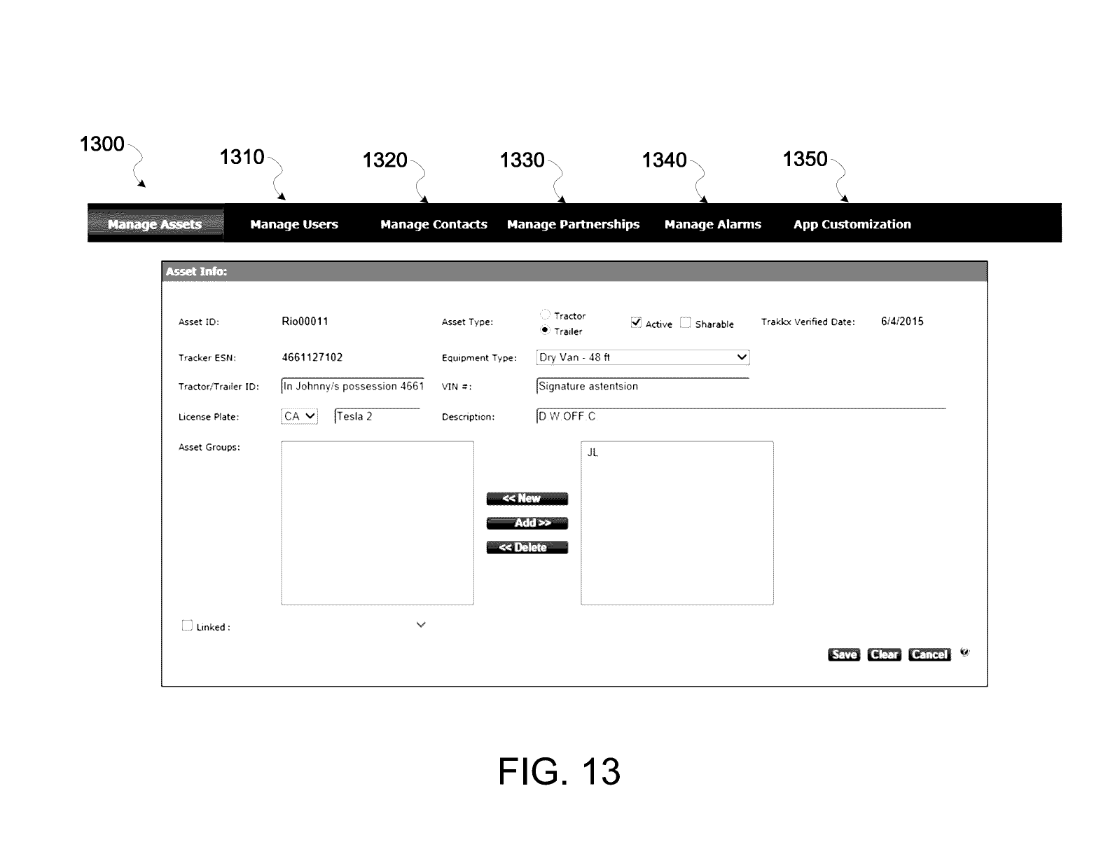

Referring to FIGS. 13 through 22, various example interfaces of the Administration View will now be discussed, according to some embodiments.

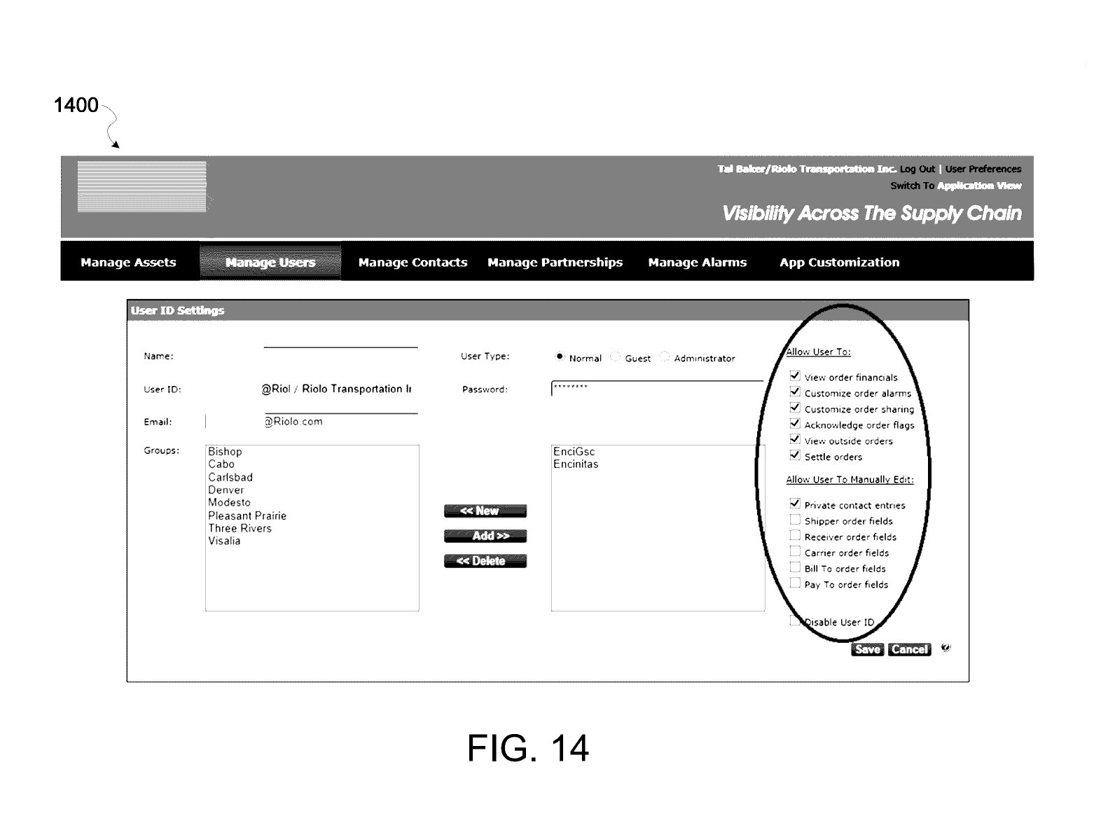

In FIG. 13, illustration 1300 shows a display for a Manage Assets view, which is for setting company-level asset configurations, according to some embodiments Similarly, company-level user management settings are available through the Manage Users view 1310. The Administration View also includes a tab for Manage Contacts 1320, Manage Partnerships 1330, Manage Alarms 1340, and App Customization 1350, according to some embodiments. Each has a summary view and drill down page for detailed property modification. In Manage Assets, available Freight tracker attached to tractors or trailer assets are defined. In FIG. 14, illustration 1400 shows a detailed user property view from the Manage Users tab, where the company administrator user can control a normal user's behavior for security or business practice reasons. For example, various settings on the right may be toggled to control different views of the selected normal user.

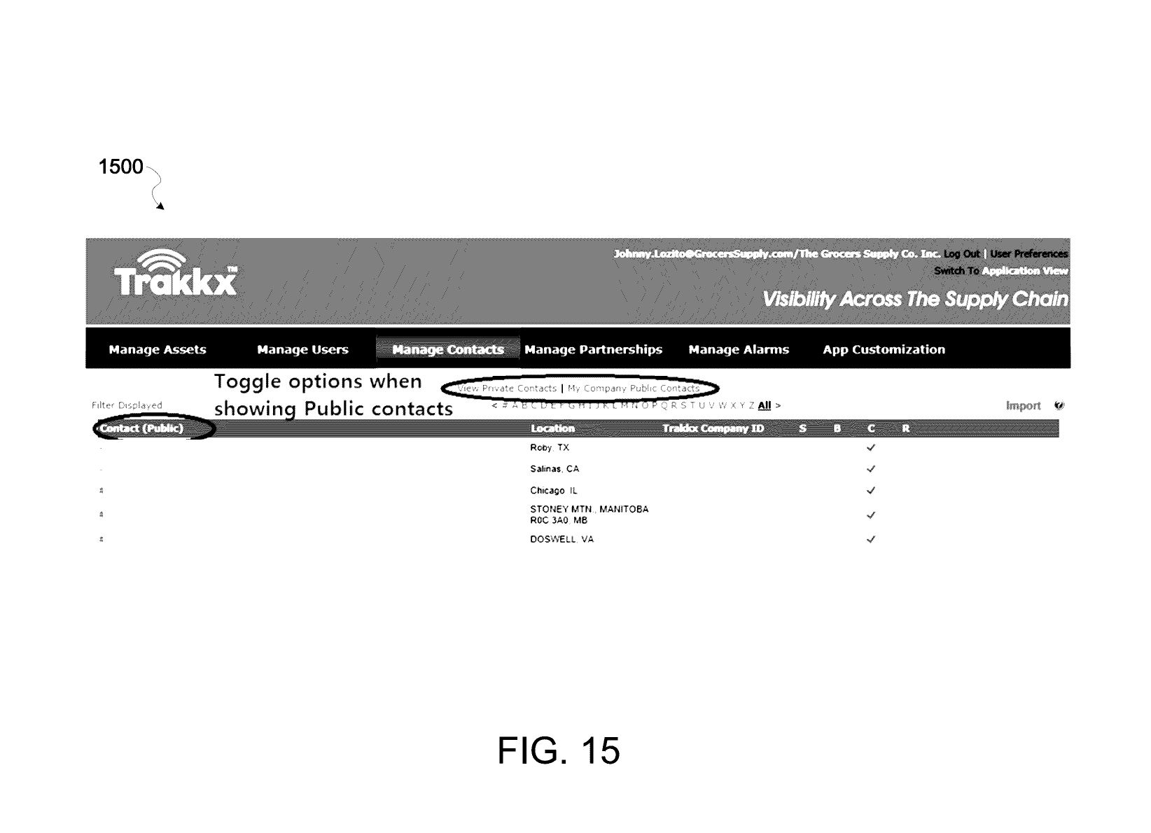

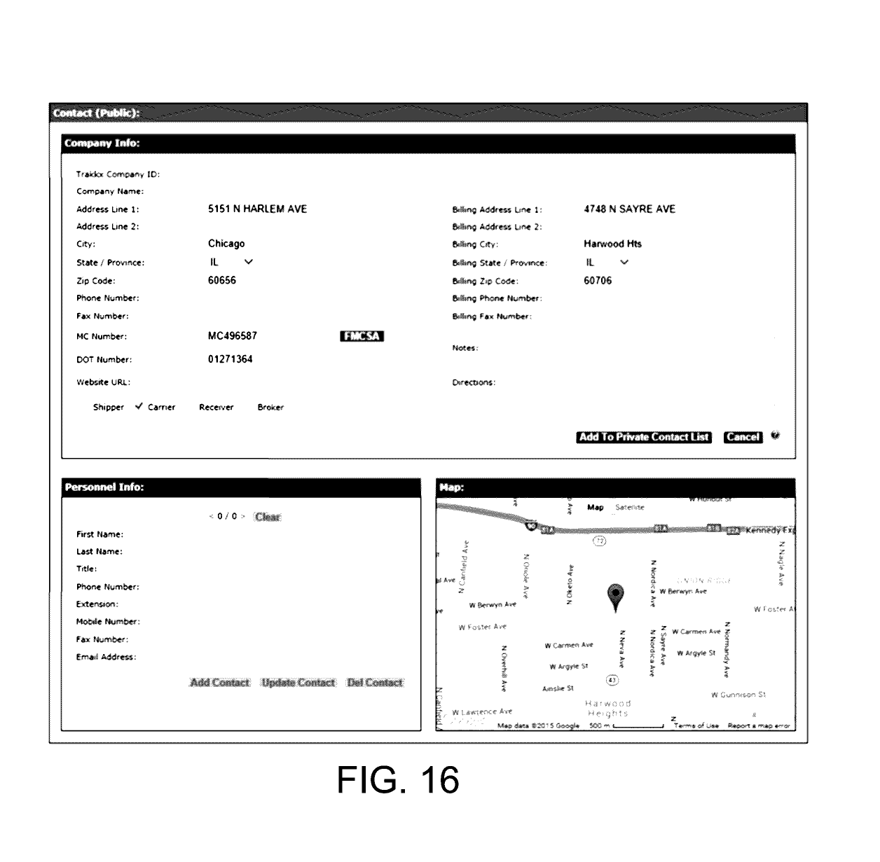

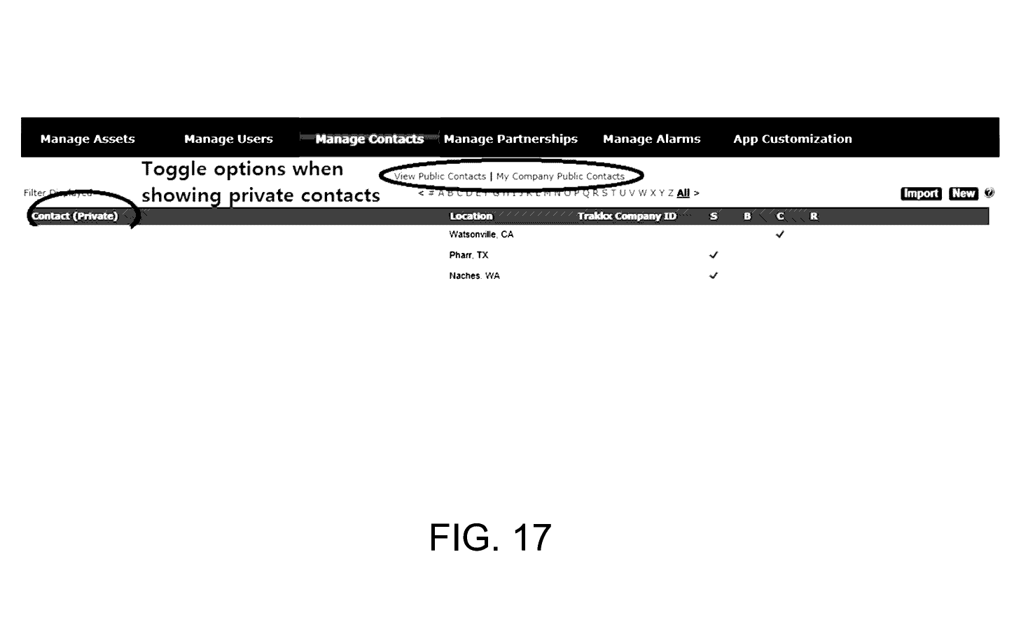

Referring to FIGS. 15, 16, and 17, various views of the Manage Contacts tab are shown. In illustration 1500 of FIG. 15, the main page for the Manage Contacts is shown, which is for company-level contact management. There are three types of contacts under Administration View, Public, Private, and My Company Public while only two types under Application View, Public and Private, where only user-level contact management is possible. Public contacts are from a Federal Motor Carrier Safety Administration (FMCSA) database in some embodiments, and are updated regularly as well as on-the-fly whenever being referenced, behind the scenes, for the most up to date information. Otherwise, public contacts may be read-only for data integrity in the dashboard according to the present disclosures. An administrator user can add public contacts to the company's private contact list and maintain it to be available for the Order Entry page's autofill/autocomplete feature. Private contacts can be modified, if necessary, at the company or user-level for additional flexibility. Different toggling options are provided based on contact type selection and FIG. 17 is an example for when viewing private contacts is selected. Note that the public or private detail contact page contains a location map for easy lookup and surrounding assessment, an example of which is shown in FIG. 16.

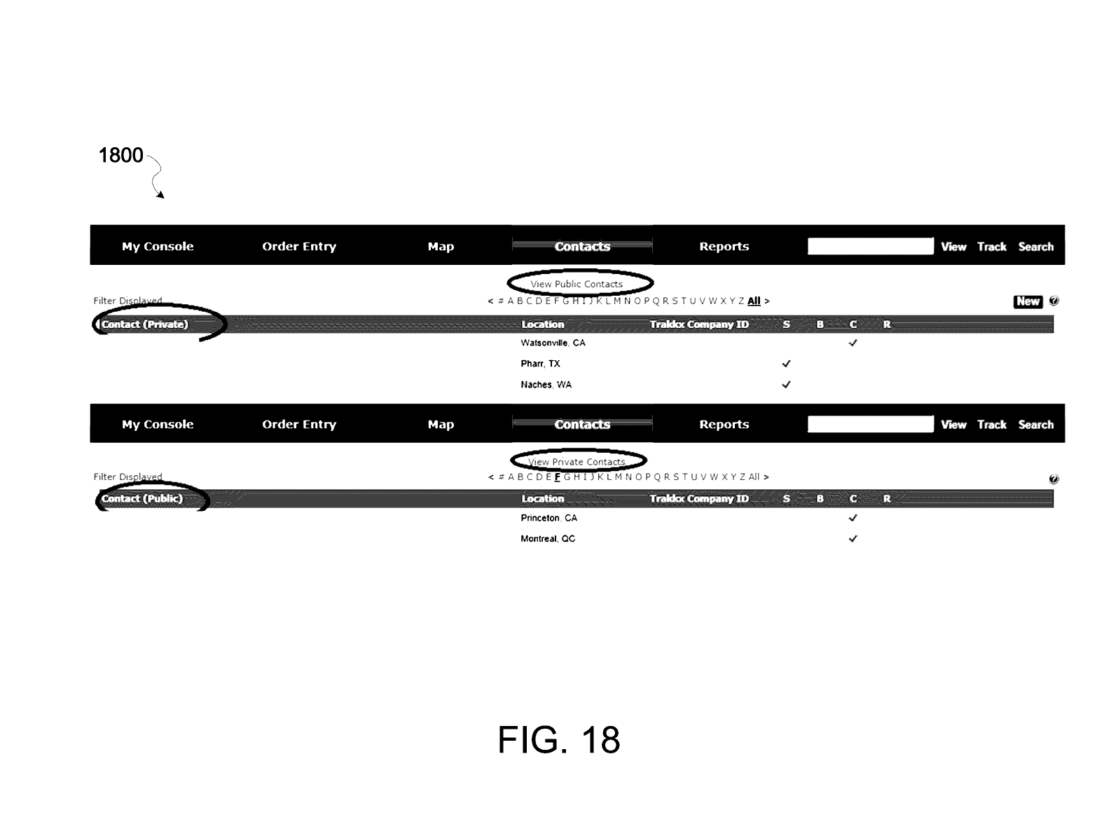

Referring to FIG. 18, the user-level contact management tab in illustration 1800 may be governed by company-level/administration contact management explained the above. In this case, a company administrator can compile a company's private list from public contacts and limit a normal users' ability to modify the private contact's information. Also, as discussed above, normal users (in Application View) can toggle between only Public and Private contact lists, as shown in FIG. 18.

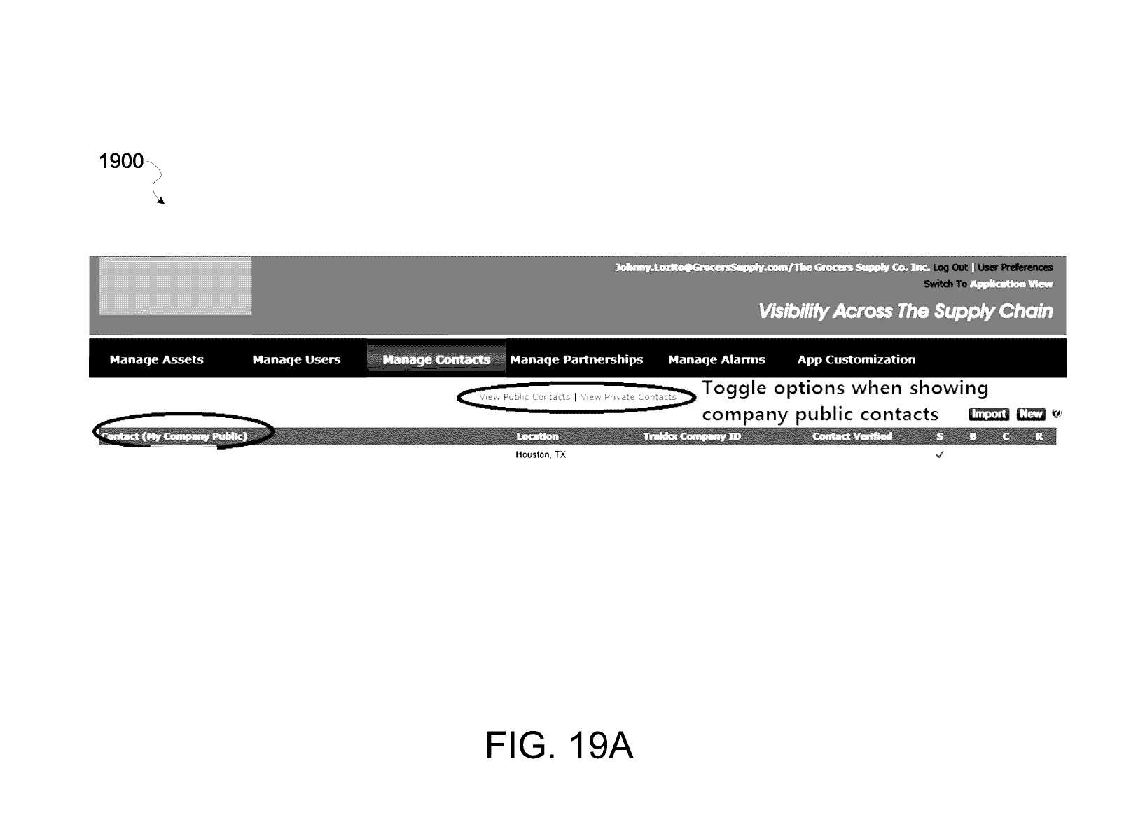

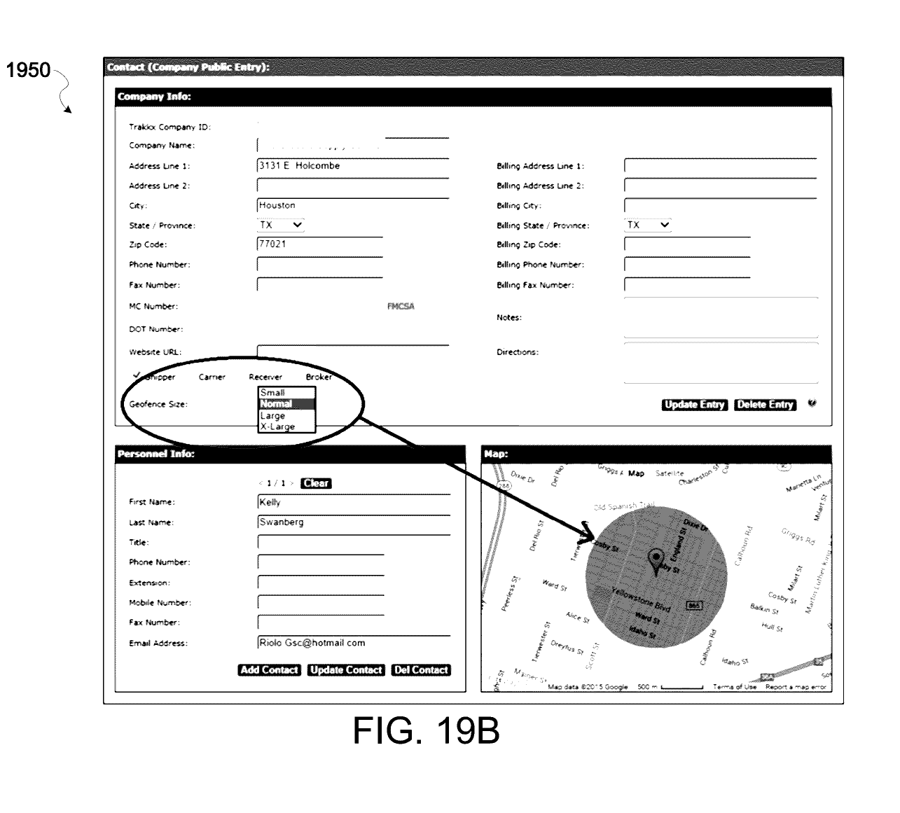

Referring to FIGS. 19A and 19B, two views 1900 and 1950 are shown that illustrate features of My Company Public contacts in the Administration View's Manage Contacts tab. In FIG. 19A, a user can select from the Manage Contacts page an option to view public contacts. The My Company Public contacts page maintains a freight company's public entry, showing the company's claimed public presence with a verification status. For example, as companies are signing up for the freight company's website, they have to be verified for their identities for business security reasons, and the identification process may be executed by a freight company authority. These statuses can be checked here on the example page shown in FIG. 19B. Moreover, a freight company of a Shipper and/or Receiver role, which may have multiple locations, can maintain them under one freight company account by adding more public entries under the same Freight company ID. For example, Freight company A can have entries like Freight company A—San Diego, Freight company A—Boston, etc. under the same account. Then, they can be picked up by another company as private contacts and can be used in their Order Entry page. Furthermore, referring to FIG. 19B, for a Shipper and Receiver, a detailed Company Public Entry page provides the capability to configure a geofencing size so that it could control the radius being used to determine order progress status. For example, some dense area pickup locations would be better suited to have a small geofencing radius to reduce interference with other nearby pickup locations or some users may want to know the delivery status sooner by increasing geofencing size and setting status change alarm. The geofence size makes this fine control possible.

According to some embodiments, a Manage Partnership tab is also included in the dashboard. Further details of this feature are explained in US non-provisional application (Attorney Docket No. 1402872.00007_TRX007), which is incorporated herein by reference.

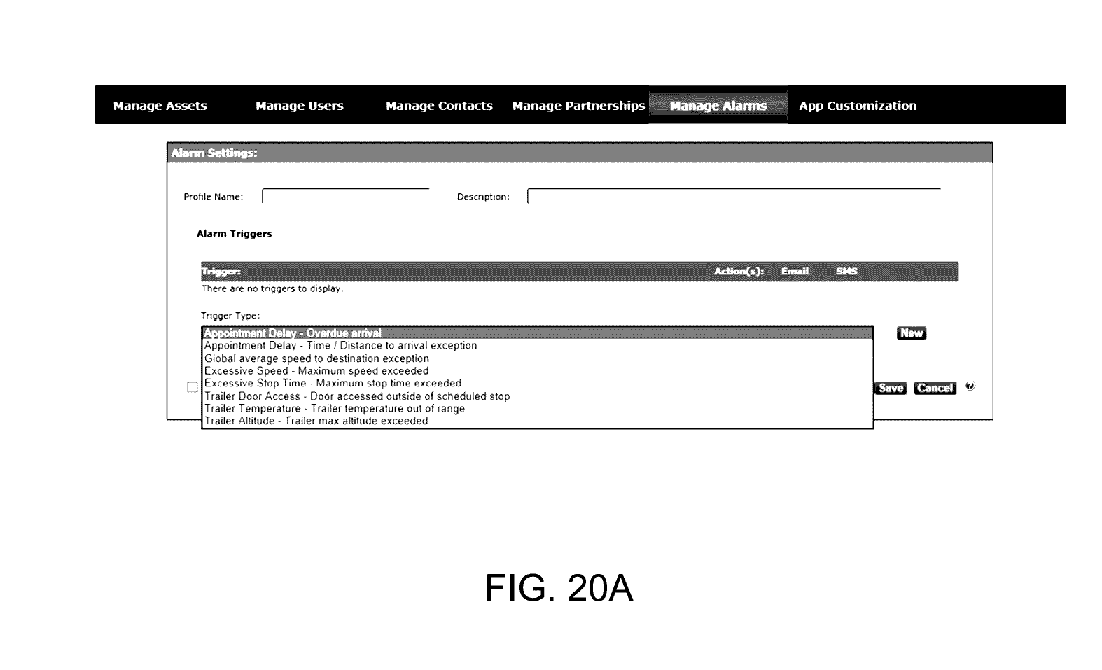

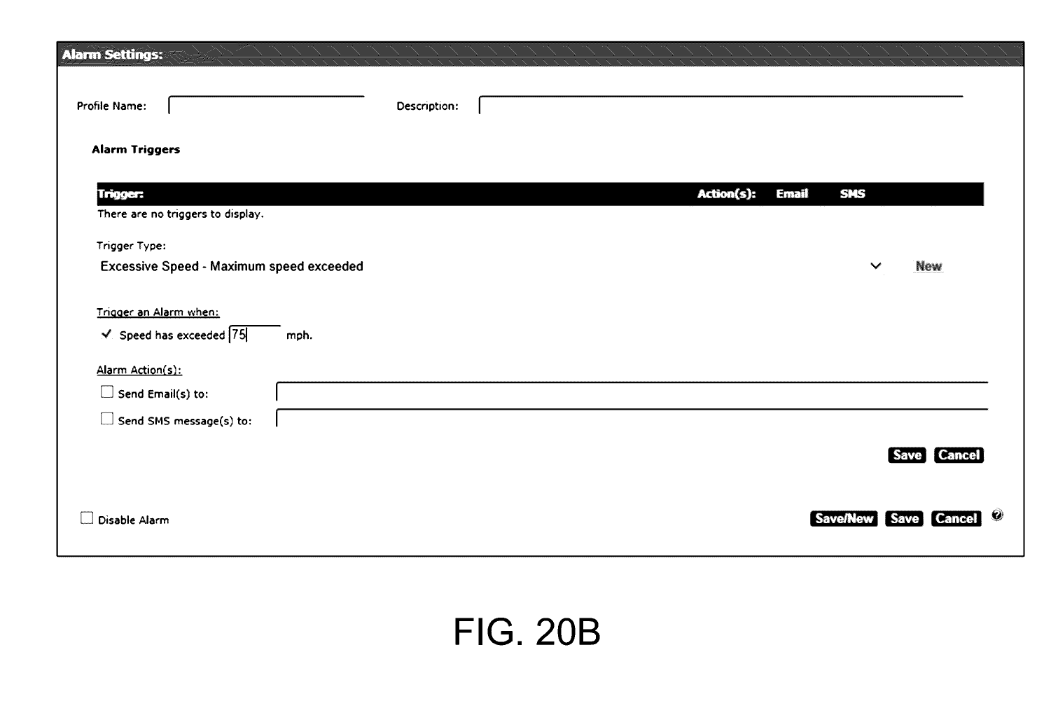

Referring to FIGS. 20A and 20B, the Manage Alarms tab is discussed. Here, the Manage Alarms tab is to define and maintain a company-level alarm profile. Various alarm trigger conditions can be set on product integrity, driver behavior or possible delay situation such as Trailer Temperature, Excessive Driving Speed, Appointment Delay and etc. Alarm notifications can be delivered to a configurable target audience by email or SMS or other communication means. Once a company-level alarm profile is set, it can be easily applied in an Order Entry's order-level alarm configuration. FIG. 20A shows examples of various trigger types in a pull down menu, while FIG. 20B shows examples of other alarm settings, such as setting other conditions based on the trigger type selected. In this example, excessive speed is a trigger type selected, and additional details about when an alarm is triggered are shown. The alarm may also be configured to perform a particular alarm action, such as immediately sending an email or text message. These alarms may then be tied to any and all orders currently being monitored, that are displayed in the status menus described in previous figures.

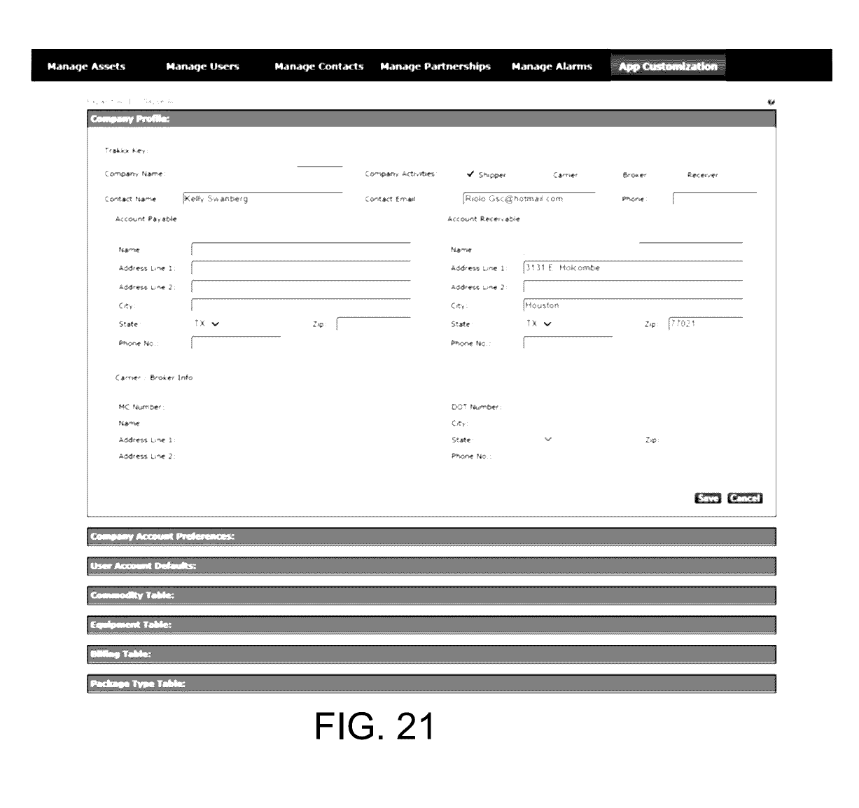

Referring to FIG. 21, an App Customization tab is discussed. This page is typically the page to visit first when a company signs up for the dashboard system of the present disclosures and to keep coming back to optimize the website behavior to tailor for its business needs and practices. The company profile is set here and a company's target Commodity, Equipment, Billing and Package types can be picked from an available list. Also, various granular company-level property defaults for the Application Preference and User Account Preference/Setting can be defined. Note that the user-level preference can be modified at the Application View but allowing modification itself can be controlled here.

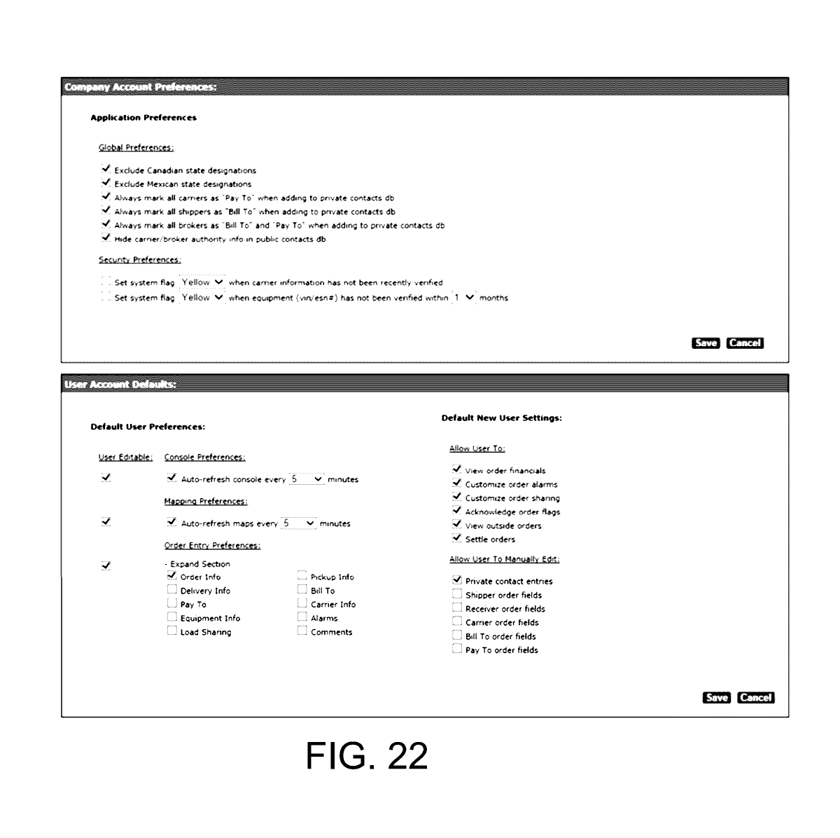

Referring to FIG. 22, various account preferences are shown, based on the App Customization tab. As shown above, the dashboard website user interface differentiates itself by maximizing usability, visibility and flexibility for logistics business as well as providing controllability at the same time. Every feature is tightly dependent and works together to capture and support the dynamics of multiple business roles and actions with single consistent interface design.

Referring to FIG. 23, the block diagram illustrates components of a machine 2300, according to some example embodiments, able to read instructions 2324 from a machine-readable medium 2322 (e.g., a non-transitory machine-readable medium, a machine-readable storage medium, a computer-readable storage medium, or any suitable combination thereof) and perform any one or more of the methodologies discussed herein, in whole or in part. Specifically, FIG. 23 shows the machine 2300 in the example form of a computer system (e.g., a computer) within which the instructions 2324 (e.g., software, a program, an application, an applet, an app, or other executable code) for causing the machine 2300 to perform any one or more of the methodologies discussed herein may be executed, in whole or in part.

In alternative embodiments, the machine 2300 operates as a standalone device or may be connected (e.g., networked) to other machines. In a networked deployment, the machine 2300 may operate in the capacity of a server machine 110 or a client machine in a server-client network environment, or as a peer machine in a distributed (e.g., peer-to-peer) network environment. The machine 2300 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 2324, sequentially or otherwise, that specify actions to be taken by that machine. Further, while only a single machine 2300 is illustrated, the term “machine” shall also be taken to include any collection of machines that individually or jointly execute the instructions 2324 to perform all or part of any one or more of the methodologies discussed herein.

The machine 2300 includes a processor 2302 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 2304, and a static memory 2306, which are configured to communicate with each other via a bus 2308. The processor 2302 may contain microcircuits that are configurable, temporarily or permanently, by some or all of the instructions 2324 such that the processor 2302 is configurable to perform any one or more of the methodologies described herein, in whole or in part. For example, a set of one or more microcircuits of the processor 2302 may be configurable to execute one or more modules (e.g., software modules) described herein.

The machine 2300 may further include a video display 2310 (e.g., a plasma display panel (PDP), a light emitting diode (LED) display, a liquid crystal display (LCD), a projector, a cathode ray tube (CRT), or any other display capable of displaying graphics or video). The machine 2300 may also include an alphanumeric input device 2312 (e.g., a keyboard or keypad), a cursor control device 2314 (e.g., a mouse, a touchpad, a trackball, a joystick, a motion sensor, an eye tracking device, or other pointing instrument), a storage unit 2316, a signal generation device 2318 (e.g., a sound card, an amplifier, a speaker, a headphone jack, or any suitable combination thereof), and a network interface device 2320.

The storage unit 2316 includes the machine-readable medium 2322 (e.g., a tangible and non-transitory machine-readable storage medium) on which are stored the instructions 2324 embodying any one or more of the methodologies or functions described herein, including, for example, any of the descriptions of FIGS. 1-22. The instructions 2324 may also reside, completely or at least partially, within the main memory 2304, within the processor 2302 (e.g., within the processor's cache memory), or both, before or during execution thereof by the machine 2300. The instructions 2324 may also reside in the static memory 2306.

Accordingly, the main memory 2304 and the processor 2302 may be considered machine-readable media 2322 (e.g., tangible and non-transitory machine-readable media). The instructions 2324 may be transmitted or received over a network 2326 via the network interface device 2320. For example, the network interface device 2320 may communicate the instructions 2324 using any one or more transfer protocols (e.g., HTTP). The machine 2300 may also represent example means for performing any of the functions described herein, including the processes described in FIGS. 1-22.

In some example embodiments, the machine 2300 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 2322 able to store data temporarily or permanently and may be taken to include, but not be limited to, random-access memory (RAM), read-only memory (ROM), buffer memory, flash memory, and cache memory. While the machine-readable medium 2322 is shown in an example embodiment to be a single medium, the term “machine-readable medium” should be taken to include a single medium or multiple media (e.g., a centralized or distributed database 115, or associated caches and servers) able to store instructions 2324. The term “machine-readable medium” shall also be taken to include any medium, or combination of multiple media, that is capable of storing the instructions 2324 for execution by the machine 2300, such that the instructions 2324, when executed by one or more processors of the machine 2300 (e.g., processor 2302), cause the machine 2300 to perform any one or more of the methodologies described herein, in whole or in part. Accordingly, a “machine-readable medium” refers to a single storage apparatus or device 130 or 150, as well as cloud-based storage systems or storage networks that include multiple storage apparatus or devices 130 or 150. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 2322 is non-transitory in that it does not embody a propagating signal. However, labeling the tangible machine-readable medium 2322 as “non-transitory” should not be construed to mean that the medium is incapable of movement; the medium should be considered as being transportable from one physical location to another. Additionally, since the machine-readable medium 2322 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 2322 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 2302 or a group of processors 2302) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 2302 or other programmable processor 2302. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 2308) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 2302 that are temporarily configured (e.g., by software) or permanently configured to perform the relevant operations. Whether temporarily or permanently configured, such processors 2302 may constitute processor-implemented modules that operate to perform one or more operations or functions described herein. As used herein, “processor-implemented module” refers to a hardware module implemented using one or more processors 2302.

Similarly, the methods described herein may be at least partially processor-implemented, a processor 2302 being an example of hardware. For example, at least some of the operations of a method may be performed by one or more processors 2302 or processor-implemented modules. As used herein, “processor-implemented module” refers to a hardware module in which the hardware includes one or more processors 2302. Moreover, the one or more processors 2302 may also operate to support performance of the relevant operations in a “cloud computing” environment or as a “software as a service” (SaaS). For example, at least some of the operations may be performed by a group of computers (as examples of machines 2300 including processors 2302), with these operations being accessible via a network 2326 (e.g., the Internet) and via one or more appropriate interfaces (e.g., an API).

The performance of certain operations may be distributed among the one or more processors 2302, not only residing within a single machine 2300, but deployed across a number of machines 2300. In some example embodiments, the one or more processors 2302 or processor-implemented modules may be located in a single geographic location (e.g., within a home environment, an office environment, or a server farm). In other example embodiments, the one or more processors 2302 or processor-implemented modules may be distributed across number of geographic locations.

Unless specifically stated otherwise, discussions herein using words such as “processing,” “computing,” “calculating,” “determining,” “presenting,” “displaying,” or the like may refer to actions or processes of a machine 900 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A freight management system for improving logistics in shipping transactions, comprising:
at least one memory;
at least one processor coupled to the at least one memory, and configured to:
cause display of a graphical dashboard user interface of the freight management system, the graphical dashboard user interface comprising:
a centralized console display configured to display statuses of a plurality of shipping transactions, the statuses including a regularly updating current location status for each of the plurality of shipping transactions;
a reports display configured to receive inputs for generating reports of pending and completed shipping transactions;
a map display configured to display a live update of a route, overlaid on a map, of a selected shipping transaction among the plurality of shipping transactions; and
an administration menu comprising an asset management page, a user management page, a contacts management page, a partnership management page, and an alarm management page;
wherein the administration menu is configured to receive inputs to control privileges and display settings of the centralized console display, the reports display, and the map display.

2. The system of claim 1, wherein the centralized console display is further configured to:
receive a cursor input placed over a status of a shipping transaction among the plurality of shipping transactions; and
in response, cause display of a floating window overlaid on the console display and displaying additional information about the shipping transaction.

3. The system of claim 1, wherein the statuses further comprise an order number, a pickup date, a driver name, an origin city, a destination city, a commodity type, a purchase order identifier, a receiver purchase order identifier, a delivery date, a payment value, and a load status identifier.

4. The system of claim 1, wherein the graphical dashboard user interface further comprises a filter application configured to filter displays of the statuses of the plurality of shipping transactions in the centralized console display, based on one or more of the statuses.

5. The system of claim 4, wherein the filter application is configured to filter displays of the statuses based further on current location of the shipping transactions, and partnerships formed with freight companies associated with the shipping transactions.

6. The system of claim 4, wherein the filter application is configured to filter displays of the statuses based further on one or more load status identifiers, the load status identifiers comprising: an “available” status, a “booked” status, a “dispatched” status, a “loading” status, a “loaded” status, an “unloading” status, an “empty” status, a “settled” status, a “partial” status, a “void” status, and an “outside” status.

7. The system of claim 4, wherein the graphical dashboard user interface is further configured to generate pre-selected filters for filtering the statuses of the plurality of shipping transactions, using the filter application.

8. The system of claim 4, wherein the graphical dashboard user interface is further configured to cause display a first version of the centralized console display and a second version of the centralized console display concurrently; wherein the first version of the centralized console display includes statuses of the plurality of shipping transactions filtered by a first filter using the filter application, and the second version of the centralized console display includes statuses of the plurality of shipping transaction filtered by a second filter using the filter application.

9. The system of claim 8, wherein the graphical dashboard user interface is further configured to provide live updates to both the first version and second version of the centralized console display, and display updated statuses only of those that pass through the respective first and second filters.

10. The system of claim 1, wherein the reports comprise summarized information of a total number of shipping transactions among the plurality of shipping transactions, the summarized information including, regarding the shipping transactions among the total number of shipping transactions: a unique number of shippers, a unique number of receivers, a unique number of brokers, a unique number of carriers, a unique number of recipients billed to, a unique number of recipients paid to, a total amount billed, an average amount billed, a total amount paid, an average amount paid, a total amount of profit, and an average amount of profit.

11. The system of claim 10, wherein the summarized information further includes, regarding the shipping transactions among the total number of shipping transactions: a total number of shipping pick ups, an average number of pick ups per shipment, a number of on-time pick ups, a percentage of on-time pick ups, a total number of shipping drop offs, an average number of drop offs per shipment, a number of on-time drop offs, and a percentage of on-time drop offs.

12. The system of claim 10, wherein the reports display is further configured to:
receive a cursor input placed over one item of the summarized information; and
in response, cause display of an enumerated list of shipping transactions tabulated within the one item of summarized information.

13. The system of claim 1, wherein the asset management page of the administrative menu comprises information about a shipping asset, including: whether the asset is a tractor or a trailer, whether the asset is active, equipment type for storing shipping products, and unique identification information of the asset.

14. The system of claim 1, wherein the inputs to control the privileges and display settings of the centralized console display, the reports display, and the map display comprise inputs to allow users to: view order financials, customize order alarms, customize order sharing, acknowledge order flags, view outside orders, and settle orders.

15. The system of claim 1, wherein the inputs to control the privileges and display settings of the centralized console display, the reports display, and the map display comprise inputs to allow users to manually edit: private contact entries, shipper order fields, receiver order fields, carrier order fields, bill to order fields, and pay to order fields.

16. The system of claim 1, wherein the contacts management page is configured to display public contacts available in a public shipping database, and display private contacts not available in the public shipping database.

17. The system of claim 1, wherein the contacts management page is configured to display information of a single contact, including personnel information, shipping license information, geographic location information expressed in a map display view, and a geofencing radius for specifying an area in which the contact is able to provide shipping services to.

18. The system of claim 1, wherein the alarm management page is configured to activate an alarm that alerts a user to a trigger condition related to a measure of performance during a shipping transaction.

19. A graphical dashboard user interface of a freight management system operated by at least one memory and at least one processor of the freight management system, the user interface comprising:
a centralized console display configured to display statuses of a plurality of shipping transactions, the statuses including a regularly updating current location status for each of the plurality of shipping transactions;
a reports display configured to receive inputs for generating reports of pending and completed shipping transactions;
a map display configured to display a live update of a route, overlaid on a map, of a selected shipping transaction among the plurality of shipping transactions; and
an administration menu comprising an asset management page, a user management page, a contacts management page, a partnership management page, and an alarm management page;
wherein the administration menu is configured to receive inputs to control privileges and display settings of the centralized console display, the reports display, and the map display.

20. A computer-readable medium having no transitory signals and embodying instructions that, when executed by a processor, perform operations comprising:
causing display of a graphical dashboard user interface of the freight management system, the graphical dashboard user interface comprising:
a centralized console display configured to display statuses of a plurality of shipping transactions, the statuses including a regularly updating current location status for each of the plurality of shipping transactions;
a reports display configured to receive inputs for generating reports of pending and completed shipping transactions;
a map display configured to display a live update of a route, overlaid on a map, of a selected shipping transaction among the plurality of shipping transactions; and
an administration menu comprising an asset management page, a user management page, a contacts management page, a partnership management page, and an alarm management page;
wherein the administration menu is configured to receive inputs to control privileges and display settings of the centralized console display, the reports display, and the map display.
